(19) United States
(12) Patent Application Publication
(10) Pub. No.: US 2025/0084841 A1
(43) Pub. Date: Mar. 13, 2025

(54) ACTION-ORIENTED MONITORING SYSTEM FOR ROTATING EQUIPMENT

(71) Applicant: Saudi Arabian Oil Company, Dhahran (SA)

(72) Inventors: Kamarul Ariffin Amminudin, Dhahran (SA); Ziyad H. Ayadah, Hofuf (SA); Abdullah A. Alzahrani, Riyadh (SA)

(21) Appl. No.: 18/465,728

(22) Filed: Sep. 12, 2023

(51) Int. Cl. F04B 49/06; F04B 23/00

(52) U.S. Cl. CPC F04B 49/06; F04B 23/00

(57) ABSTRACT

A method for controlling a pump system, the method comprising: receiving, from a flow sensor, flow data representing fluid flow at an input of a pump in a pump system, the pump system comprising a recycle line configured to redirect flow from an output of the pump to the input of the pump; determining, based on the flow data, configuration data specifying a hardware configuration of the pump system, and a model specifying a performance history of the pump system, that a recycle event is occurring or about to occur; and generating, based on the determining, an alert comprising a recommendation for a remedial action to reduce an amount of fluid flow through the recycle line during the recycle event relative to a baseline amount of fluid flow through the recycle line.

### TECHNICAL FIELD

This specification relates generally to control systems. Specifically, this specification relates to monitoring pumps at facilities such as a gas oil separation plant (GOSP) or a hydrocarbon processing facility or refinery.

### BACKGROUND

Energy performance metrics are normally used in an operating facility to measure how energy efficient the facility is with respect to a given target or Key Performance Indicator (KPI). One of the commonly used energy metrics is the energy intensity index, defines as a total energy consumed per unit of production. Hence, for a lower energy intensity index there is a corresponding higher an energy efficiency for a given facility.

A pumping apparatus can include a hydraulic pump and electric motor as two separate components coupled via a rotating shaft. Pumps may be positive-displacement such as hydrostatic, gear, screw, diaphragm, etc., or non-positive-displacement such as hydrodynamic, centrifugal, propeller, etc. A pump is typically associated with an electric motor. Electric motors can be powered by direct current (DC) sources or by alternating current (AC) sources, such as a power grid, inverters, or generators.

An electrical motor may operate through interaction of the motor magnetic field with motor winding currents to generate force. The motor may include a motor stator and a motor rotor. The term “stator” is derived from the word stationary. The stator may be a stationary electrical component having a group of individual electro-magnets arranged in such a way to form a hollow cylinder, with one pole of each magnet facing toward the center of the group. The term “rotor” is derived from the word rotating. The rotor may be the rotating electrical component having a group of electro-magnets arranged around a cylinder, with the poles facing toward the stator poles. In some examples, the rotor may be located inside the stator and mounted on the motor shaft. These motor components can make the rotor rotate which in turn may rotate the motor shaft. This rotation may occur because of the magnetic phenomenon that unlike magnetic poles attract each other and like poles repel.

Thus, the motor rotor may be a moving component of the electromagnetic system in the electric motor. In particular, the interaction between the windings and magnetic fields produces a torque around the axis of the motor rotor to rotate the motor rotor. This force may rotate the shaft that couples the motor with the discrete pump.

A pump may be a submersible pump which is coupled to a submersible or hermetically sealed motor separate from the pump body. The assembly may be submerged in the fluid to be pumped and thus generally avoid pump cavitation. Submersible pumps typically push the pumped fluid to the surface. Applications of submersible pumps include drainage, sewage pumping, sewage treatment plants, general industrial pumping, slurry pumping, pond filters, seawater handling, firefighting, water well and deep well drilling, offshore drilling rigs, artificial lifts, mine dewatering, and irrigation systems. Submersible pumps may be lowered down a borehole and used for residential, commercial, municipal and industrial water extraction, and in water wells and oil wells. Lastly, for a submersible pump system, a seal section or protector is typically disposed between the pump and motor for motor protection. The protector may absorb the thrust load from the pump, transmit power from the motor to the pump, equalize motor internal and external pressures, and prevent well fluids from entering the motor.

### SUMMARY

A monitoring and control system includes an action-oriented control aspect, an action oriented control includes on intelligent or reactive control system in which actions are recommended to an operator or automatically performed based on measuring particular performance values, such as parameter values related to pump operation (such as power or fluid flow), the monitoring and control system includes a power monitoring application equipped with advisory features supported by a model, such as a decision trees framework. The model recommends remedial actions to one or more operators of the pump system. In some implementations, the monitoring system, based on the output of the model, is configured to automatically perform one or more of the remedial actions without intervention of the one or more operators of the pump system. For example, if the recommended action is recommended at a confidence above a threshold value, the monitoring and control system can automatically cause the remedial action to be performed. For each remedial action performed or remedial action recommended, the monitoring and control system generates a corresponding alert or notification. In some implementations, the alert or notification is configured to escalate within a management organization associated with the pump monitoring and control system.

The one or more embodiments described in this specification can enable one or more of the following advantages. The monitoring and control system can enable substantial power savings for a facility associated with the pump system monitored by the pump monitoring and control system. In an example, the monitoring and control system can reduce power consumed on the order of several megawatts of power per year and up to millions of dollars a year by reducing or eliminating recycle flow in the pump system. In addition, reduction or elimination of the recycle flow reduces waste carbon dioxide production substantially via Scope 2 emissions reduction, on the order of 10s of kilotons of carbon dioxide per year. This is because the monitoring and control system is configured to monitor not only the power versus production performance of the pump, but also reduce or eliminate recycle flow by recycle flow monitoring. The recycle flow monitoring of the monitoring and control system enables the pump control parameters to be changed to reduce or eliminate the waste carbon dioxide and further improve pump operation than from power monitoring alone.

The systems and processes described herein overcome disadvantages resulting from focusing on typical power performance monitoring of the rotating equipment. For example, updating the control of the pump based on the monitoring of the performance of the pump alone, without monitoring the recycle flow, can result in an inaccurate control of the pump system. Deviations from the intended performance target may signal the possible deficiency of the equipment in question, which can be addressed from the equipment mechanical reliability issues. The monitoring and control system monitors the recycle flow and therefore can reduce waste from the pump system to a greater degree than focusing on the production and power of the pump alone.

Embodiments of these systems and methods can include one or more of the following features.

In a general aspect, a method for controlling a pump system comprises receiving, from a flow sensor, flow data representing fluid flow at an input of a pump in a pump system, the pump system comprising a recycle line configured to redirect flow from an output of the pump to the input of the pump; determining, based on the flow data, configuration data specifying a hardware configuration of the pump system, and a model specifying a performance history of the pump system, that a recycle event is occurring or about to occur; and generating, based on the determining, an alert comprising a recommendation for a remedial action to reduce an amount of fluid flow through the recycle line during the recycle event relative to a baseline amount of fluid flow through the recycle line.

In some implementations, the method further comprises causing performance of the remedial action in the pump system.

In some implementations, causing performance of the remedial action in the pump system occurs automatically based on a confidence value associated with the recommendation.

In some implementations, causing performance of the remedial action in the pump system occurs after receiving validation input from an operator of the pump system.

In some implementations, reducing the amount of fluid flow through the recycle line comprises eliminating fluid flow through the recycle line and preventing the recycle event.

In some implementations, the remedial action comprises shutting down the pump and diverting fluid flow to one or more other pumps in the pump system.

In some implementations, the remedial action comprises opening a recycle line valve on the recycle line to control fluid flow through the recycle line.

In a general aspect, a system for controlling a pump includes a flow sensor configured to measure flow data representing fluid flow at the flow sensor; a pump; and at least one controller, the controller configured to perform operations comprising: receiving, from the flow sensor, flow data representing the fluid flow at an input of the pump in a pump system, the pump system comprising a recycle line configured to redirect flow from an output of the pump to the input of the pump; determining, based on the flow data, configuration data specifying a hardware configuration of the pump system, and a model specifying a performance history of the pump system, that a recycle event is occurring or about to occur; and generating, based on the determining, an alert comprising a recommendation for a remedial action to reduce an amount of fluid flow through the recycle line during the recycle event relative to a baseline amount of fluid flow through the recycle line.

In a general aspect, one or more non-transitory computer readable media storing instructions for controlling a pump in a pump system by a controller, the instructions, when executed by a processor of the controller, configured to cause the controller to perform operations comprising: receiving, from a flow sensor, flow data representing fluid flow at an input of a pump in a pump system, the pump system comprising a recycle line configured to redirect flow from an output of the pump to the input of the pump; determining, based on the flow data, configuration data specifying a hardware configuration of the pump system, and a model specifying a performance history of the pump system, that a recycle event is occurring or about to occur; and generating, based on the determining, an alert comprising a recommendation for a remedial action to reduce an amount of fluid flow through the recycle line during the recycle event relative to a baseline amount of fluid flow through the recycle line.

The details of one or more embodiments are set forth in the accompanying drawings and the description below. Other features and advantages will be apparent from the description and drawings, and from the claims.

### BRIEF DESCRIPTION OF THE DRAWINGS

FIG. 1 is a diagram that illustrates an example of a pump configuration that includes a recycle flow.

FIG. 2 is a graph illustrating a relationship between reducing recycling flow and increasing power savings.

FIG. 3A is a diagram that illustrates a recycling configuration for a pump system.

FIG. 3B is a diagram that illustrates a recycling configuration for a pump system.

FIG. 4 includes diagrams that illustrate a process of reducing or eliminating recycle flow in a pump system.

FIG. 5 is a flow diagram that illustrates a process for determining remedial actions when recycle flow is not reduced or eliminated.

FIGS. 6A-6D each include a respective user interface of the pump monitoring and control system.

FIG. 7 shows an example process for controlling a pump system.

FIG. 8 is a diagram of an example computing system.

FIG. 9 illustrates hydrocarbon production operations.

### DETAILED DESCRIPTION

Systems and methods are described for action-oriented power monitoring for rotating equipment such as pumps, compressors, or other rotating equipment. Though many kinds of rotating equipment can be monitored and controlled by the monitoring systems and associated processes described herein, pumps are used as an example embodiment throughout this specification. However, the models and control systems described herein with respect to the pumps are not restricted to pumps only but can be used for other such equipment and other similar facilities. The pumps can be included in at facilities such as a gas oil separation plant (GOSP) or a hydrocarbon processing facility or refinery. In some implementations, the pump can be included at other types of facilities, such as food processing facilities, factories, automotive manufacturing facilities, wastewater management facilities, or other such similar processing or manufacturing facilities that use pumps or other rotating equipment.

Power monitoring for rotating equipment can include monitoring one or more values that measure pump power performance, and one or more values that measure a pump recycle flow rate. A monitoring and control system is configured to adjust the operation of a pump by monitoring actual power consumption of the pump (e.g., in real-time) and comparing the actual power consumption of the pump to a power performance target, the power performance target can be represented by one or more parameter values that together specify an optimal operation of the pump such that actual power consumption is minimized or otherwise optimal for operation of the pump, the monitoring system is also configured to measure a flow rate for the pump system, such as a recycle flow rate in the pump system. The monitoring and control system is configured to measure the recycle flow rate intermittently or continuously (e.g., in real-time), as subsequently described herein.

The monitoring and control system is configured to determine the recycle flow rate relative to the actual power consumption of the pump and determine the optimal operation of the pump based on these two factors. In some implementations, an optimal operation of the pump can include a minimized power consumption and recycle flow while maximizing production of oil or gas. For example, if a recycle flow rate exceeds a threshold, the operational power of the pump can be reduced such that the pump throughput is reduced and the need for the recycling flow is also reduced.

The monitoring and control system is controlled based on a performance model. The performance model is developed based on two scenarios described herein. For a first scenario, data are received at the monitoring and control system from flow transmitters (e.g., flow rate sensors) that are together configured to measure each of a net suction flow and a total suction flow through the system including the pump. The monitoring and control system control parameters are trained or otherwise updated based on the data received from each of the flow rate sensors that measure the net suction flow and the total suction flow.

The monitoring and control system control parameters can be trained or otherwise updated based on a second scenario. The second scenario includes a monitoring and control system that includes one flow transmitter configured to measure the total suction flow, in this example, there is no flow transmitter configured to measure the recycle flow.

For each of these example scenarios, the monitoring and control system control parameters control operation of the pump, the control parameters are validated based on a performance gap associated with each of the two scenarios and the values of the pump control parameters. If the performance gap does not satisfy A threshold, the pump control parameters can be further adjusted or trained to other values to improve the performance gap, such as minimizing the performance gap within a threshold value. The performance gap measures the expected performance of the pump system relative to an actual performance of the pump system. A performance metric of the pump system is based on an amount of production that is achieved and a power consumed by the system to achieve that production. In some implementations, the performance metric can be set based on simulations of the pump system or other heuristic data achieve from other pump systems similar to the pump system. In some implementations, the performance gap is quantified in terms of power saving in cost and a carbon dioxide (CO2) reduction value from a nominal or expected carbon dioxide amount for given production amount from the pump system.

The monitoring and control system includes an action-oriented control aspect, an action oriented control includes on intelligent or reactive control system in which actions are recommended to an operator or automatically performed based on measuring particular performance values, such as parameter values related to pump operation (such as power or fluid flow), the monitoring and control system includes a power monitoring application equipped with advisory features supported by a model, such as a decision trees framework. The model recommends remedial actions to one or more operators of the pump system. In some implementations, the monitoring system, based on the output of the model, is configured to automatically perform one or more of the remedial actions without intervention of the one or more operators of the pump system. For example, if the recommended action is recommended at a confidence above a threshold value, the monitoring and control system can automatically cause the remedial action to be performed. For each remedial action performed or remedial action recommended, the monitoring and control system generates a corresponding alert or notification. In some implementations, the alert or notification is configured to escalate within a management organization associated with the pump monitoring and control system.

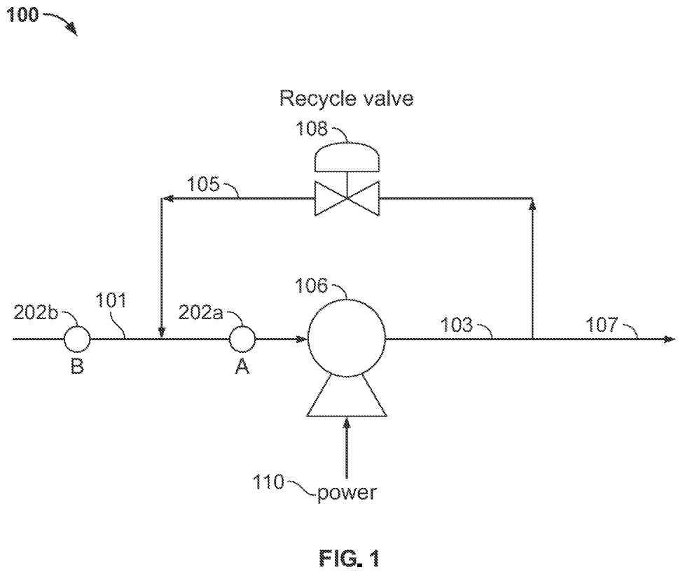

FIG. 1 is a diagram that illustrates an example of a pump system 100. The pump system 100 includes main flow line 103 and a recycle flow line 105. An input line 101 becomes the main line 103 through the pump 106. The main flow line 103 splits into the recycle flow line 105 and the output line 107. The pump 106 receives a power input 110. The recycle flow line 105 has a recycle valve 108. The recycle valve 108 can be controlled to control the flow through the recycle flow line 105. In some implementations, the recycle flow line 105 flow is increased if the pump 106 is running under a processing capacity. For example, if the input line 101 is producing too little flow (e.g., at point B), then the recycle valve 108 is opened to increase flow along the recycle flow line 105 to increase flow rate at main flow line 103 at point A. Increasing the flow in the recycle flow line 105 introduces an inefficiency into the pump system 100 because the pump 106 is drawing extra power from the power input 110 to pump the fluid through the pump system 100 more than once. The monitoring and control system described herein is configured to control flow through the pump 106 from the input line 101 to reduce or eliminate the need to cause fluid flow through the recycle flow line 105. Reducing or eliminating a fluid flow through the recycle flow line 105 increases in efficiency of the pump system 100 because less or no unnecessary power is input into the pump 106 from the power input 110.

The monitoring and control system is configured to reduce power consumption by the pump 106. The pump monitoring control system is configured to reduce or eliminate the recycle flow in the line 105. To reduce or eliminate the flow in the recycle line 105, the monitoring and control system is configured to train a model based on the operating parameters of controlling the power input 110 and the recycle valve 108. The monitoring and control system is configured to estimate power losses that occur when the recycle flow line 105 has fluid flowing through it. Specifically, the pump motor control system is configured to estimate power loss from the recycle flow line 105 and also from equipment performance losses. The monitoring and control system can also determine a cost of operating the pump 106 with extra power and a carbon footprint of operating the pump 106 with extra power.

The monitoring and control system is configured to monitor the operating parameters including how the recycle valve 108 operates and how the power input 110 changes during operation of the pump system 100. The public monitoring and control system monitors these operating parameters and determines how flow in the output line 107, main line 103, and recycle flow line 105 are affected by changes in these operating parameters for the recycle valve 108 and the power input 110. The monitoring and control system is configured to train a model, such as a machine learning model or other model, to identify when the pump 106 will be operating under capacity prior to such flow occurring and reduce a power input 110 level to avoid the need for recycling fluid flow through line 105. Over time, this can reduce or eliminate the costs associated with operating the pump 106 over a necessary power input 110 level. In other words, the pump monitoring control system is configured to predict when underflow in pump 106 will occur and scale back flow in the main line 103, and therefore reduce fluid flow in the recycle flow line 105 as much as possible and save power. The monitoring and control system can identify data signatures that suggest that the power input 110 to the pump 106 should be decreased or increased as needed. The pump monitoring control system can then take an automated action to remediate the pump operation or generate an alert or notification to cause one or more operators at the of the pump system 100 to change the operation of the pump 106.

The pump monitoring control system is configured to generate a power performance model of rotating equipment such as pumps and compressors. The pump monitoring control system is configured to operate one or more pump systems, such as pump system 100, to extract the performance data from the equipment data sheet. The correlation of interest is the relationship between power and flowrate to the rotating equipment. In some implementations, the correlation is based on a regression analysis, either linear or non-linear. The monitoring and control system is configured to validate the generated model using historical performance data to ensure that the model is accurate.

In an example, a power model that is generated for the disposal water pump is linear, as shown in equation (1):

$$Power = X * flowrate + C \qquad Equation ( 1 )$$

Power is in units of megawatts (MW), wherein flowrate is in units of millions of barrels per day (MBD), wherein X is the determined linear relationship between power and flowrate, and wherein C is a constant. The value of C can be 1.8318 MW for an example pump system 100. The value of X can be 0.0257 for an example pump system 100.

In some implementations, the model used is linear. Correlation between flowrate and power exhibits a positive linear relationship. The model is developed from either the performance data in the equipment data sheet or the actual performance test of the said equipment. Power consumption data along with the flowrate are plotted and statistically regressed (r squared) to determine X and C. The model is tested with the determined X and C to determine whether the model and actual performance are close with a threshold tolerance. Normally what has been seen is that the variation between actual and the model is within up to +/−2%. In some implementations, the historical data includes at least 2 months of data. In some implementations, the model is reviewed every six months depending on the accuracy of the performance against the actual performance. If the difference between the actual performance and the model beyond a threshold (e.g., 10-50% tolerance value) then this model is revised and revalidated accordingly to reflect the new operating condition. In some implementations, the generated model is non-linear relationship between power and flowrate, such as a quadratic relationship.

The monitoring and control system is configured to monitor several values in the pump system 100. The monitoring and control system is configured to monitor power input 110 and recycling power loss values. The values of pump power input 110 include a monitoring application in which actual power performance of the rotating equipment (e.g., pump 106) is compared with the targeted or optimum power performance as derived from the model (Equation 1). The monitoring and control system can monitor pump performance regarding an equipment efficiency and reliability. If the monitoring and control system measures an increased power consumption relative to a baseline value or expected value, the monitoring and control system can determine that there is poor performance for the rotating equipment (e.g., pump 106), which could indicate a possible sign of reliability degradation.

The monitoring and control system also monitors a recycle power loss based on measuring a flow rate through the recycle line 105. A typical example of recycle flow 105 is shown in the pump system 100, as previously described. The objective of the recycle flow for any given pump 106 is intended to protect the pump from operating at the lower flowrate than what the pump is designed for. Operating lower rates lower than what is allowable can cause the pump 106 to cavitate because the lower rate promotes two-phase fluid flow. Two-phase fluid flow is avoided to avoid damaging the pump 106 over time. As previously described, to ensure that the flow rate through the pump 106 on the main line 103 never falls below a safety threshold, the monitoring and control system opens the valve 108 to enable fluid flow through line 105 and to supplement fluid flow through the pump 106. As previously stated, opening the recycle valve 108 introduces an inefficiency into the pump system 100 because fluid is pumped through the pump 106 more than one time. The pump 106 therefore wastes some power by pumping fluid multiple times through the main line 103. The monitoring and control system models the value of the power loss that is experienced by the system 100 when the pump 106 pumps fluid in a loop through the recycle line 105 by measuring an amount of fluid flow through the line 105, such as by using one or more fluid flow sensors, as previously described.

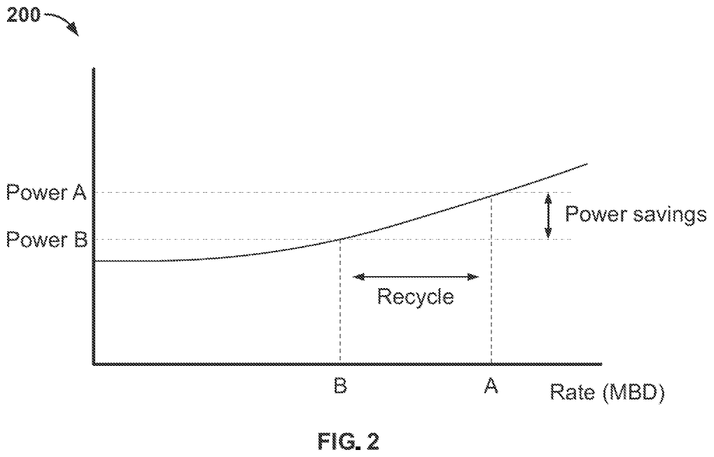

FIG. 2 is a graph 200 illustrating a relationship between reducing recycling flow and increasing power savings. The graph 200 shows an impact of an amount of fluid recycling in line 105 and a corresponding value of the power losses (wasted power) from power input 110. The proportion of recycled fluid, which is measured by the fluid flow through the cycle line 105 of pump system 100, is shown as (A-B) in graph 200. The amount of recycled fluid results in a corresponding power loss shown by (Power A-Power B) in graph 200. The monitoring and control system is configured to reduce or eliminate the proportion of fluid that is recycled through line 105, and therefore reduce an amount of power that is lost through recycling. In an example, an automated response by the monitoring and control system can be faster than the response of an operator operating the pump system 100. The savings in power consumption can result in a reduced carbon footprint, as less power is consumed by the pump system 100.

The monitoring and control system can be configured in several different ways. In a first configuration, the monitoring and control system is configured to include a plurality of flow sensors 202a-b (collectively flow sensors 202), including a flow sensor 202a at position A and a flow sensor 202b at position B in pump system 100 of FIG. 1. These flow sensors are shown in pump system 100 as first flow sensor 202a, and second flow sensor 202b. The second flow sensor 202b is on the input line 101. The second flow sensor 202b measures the initial flow to the pump 106 without considering the flow from the recycle line 105. The first flow sensor 202a is on the main flow line 103 of the pump 106 and measures total flow through the pump 106. The monitoring and control system can therefore acquire data from the pump system 100 that includes the overall input flow rate on line 101 and the secondary flow rate specific to pump 106 on line 103.

Equation 1 is updated based on the data acquired from the flow sensors 202 for determining an amount of power savings based on reducing flow in the recycle line 105. This relationship is shown in Equation (2). In some implementations, a flow sensor can be placed on the recycle line itself to directly measure the flowrate.

$$Power savings = R * ( A - B ) \qquad ( 2 )$$

where A−B is the recycle flowrate, wherein power savings is in MW, and wherein R=0.0257 for a given power system 100. Savings in financial cost can be based on current power tariffs. Savings in carbon footprint can be based on the particular emissions of the power sources involved in providing power to the pump 106.

In a second configuration, the monitoring and control system is configured to include a single flow sensor 202a on the main pump line 103. As previously stated, the sensor 202a measures the total flow to the pump 106 while there is no flow meter available for the recycle flow. The methodology calls for the recycle flow rate to be estimated from the valve 108 opening. The particular valve 108 being used can influence what data are available to the pump monitoring and control system. For example, some valves can be opened or closed at a given percentage to enable a fraction of a maximum flow rate through the line 105 to occur. The monitoring and control system determines, based on an identity or type of the valve, a correlation between valve operation (e.g., a percentage of the valve opening) and the resulting flowrates through the line 105. The monitoring and control system determines the correlation based on an operating range of the valve 108 for opening. The operational range for the valve 108 characterizes a type of the valve 108. In other words, any valve opening that beyond an operational range may result in a flowrate that is not correlated with expected performance. For example, a model is demonstrated through the logical statement:

```
Let F = percentage valve opening (%). (Valid from 0% to 100%).
Let R = flowrate of the recycle (MBD)
  If 1 < F < 51, then
    R = 0.1945 x (F) (3)
  else
  If F > 51, then
    R = 0.7392 x (F) − 27.233. (4)
  else
    R = 0.
```

The first logical statement shows that the F range between 1% and 51% will have the recycle flowrate to be determined by Equation 3 and if any value of F greater than 51, Equation 4 is used. Finally, the logic is complete when any value of F is less than 1, the flowrate is zero. This example exhibits linear equations (Equations 3 and 4) as it reflects a bilinear valve. In other type of valves, the correlations may take in the non-linear form with the flowrates.

The monitoring and control system is configured to generate alerts or other data specifying recommended remedial actions or cause remedial actions to be performed at the pump system 100. The monitoring and control system is configured cause remedial actions to be performed based on a type of the pump system. Specifically, the monitoring and control system recommends remedial actions when the system determines that there can be a cost savings by performing the remedial action. The cost savings, as previously described, can be in terms of power consumption, reduction in carbon footprint, or financial savings. The monitoring and control system measures flow rates and power consumption from the pump system being analyzed and determines whether the system is operating in an optimal way or whether remedial action can be performed. However, because not all pump systems are the same, the data can indicate remedial action based on the type of the pump system being analyzed. Therefore, based on the type of pump system being analyzed, the specific values of the parameters being measured, such as flow rate and power consumption, at which the monitoring and control system causes remedial action to be performed are tuned for the particular type of pump system being analyzed.

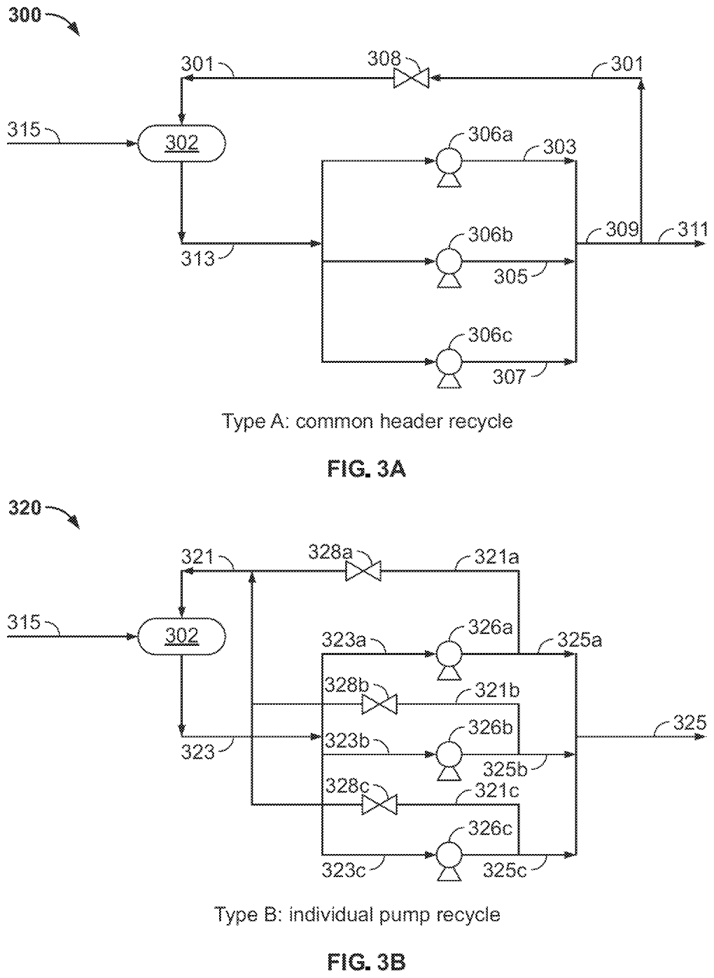

FIG. 3A is a diagram that illustrates a recycling configuration 300 for a pump system. FIG. 3B is a diagram that illustrates a recycling configuration 320 for a pump system. These are two example types of recycle configuration, but other types of pump system or other such systems can be possible. A commonly encountered system type in the processing facilities is a common header type 300, shown in FIG. 3A. In common header type system 300, a take-off point for recycle is taken from the common header at line 309 and returned to a holding vessel 302.

Specifically, system 300 includes the following system parts. System 300 includes a common input line 315 that is configured to input into a holding vessel 302. In a pump system such as system 300, a line refers to a conduit in which fluid flow can occur between one or more elements of the system 300. For example, a line can carry fluid flow through a pump that moves the fluid through the fluid line from an input to an output. A valve on a line can restrict fluid flow through the line. In some implementations, the valve, such as valve 308, can restrict fluid flow to a percentage of a maximum fluid flow. When the valve 308 is completely open, the valve can allow the maximum fluid flow through the line to occur.

A holding vessel 302 receives fluid from the recycle line 301 that passes through recycle valve 308. As previously discussed, the recycle valve 308 can be opened either completely or partially to allow fluid to flow through the recycle line 301 and back into holding container 302. Recycle line 301 branches from the common output 309, also called the common header line. The common header line 309 receives the output from each of the pumps in the system 300.

A common input line 313 is taken from the holding vessel 302. The common input line 313 branches into each of the pumps 306a, 306b, and 306c of system 300. Pump 306a is on line 303. Pump 306b is on line 305. Pump 306c is on line 307. Pumps 306a, 306 b, and 306C have parallel operations one another and are combined into a common header line 309 as a common output. A portion of the fluid flow can flow through recycle line 301. When the valve 308 is completely closed, there is no fluid flow through recycle line 301, and the output line 311 has the same fluid flow as the common header line 309. When the valve 308 is partially open or completely open, the output line 311 has only a fraction of the fluid flow of the common header line 309.

For system 300, the monitoring and control system can monitor the fluid flow on the common input line 313 and on the input line 315 in order to determine how much fluid flow is flowing through the recycle line, and some implementations, a flow sensor can be placed on the recycle line 315. Indication, the power input to each of pumps 306a, 306b, and 306c can be measured. The power inputs for respective pumps 306a-c and no flow rates for one or more of the pumps and for the common input can be used to generate a model as described previously in relation to FIG. 1. The pumps 306a-c can be identical. In some implementations, the pumps 306a-c are non-identical, but any differences are known to the monitoring and control system so that the model can be adjusted accordingly.

FIG. 3B is a diagram that illustrates a recycling configuration 320 for a pump system. The system 320 operates is now described. Three pumps 326a, 326b, and 326c (collectively pumps 326) operate individual respective recycle lines 321a, 321b, and 321c (combined into recycle lines 321). Pump 326a has input line 323a and an output that splits into recycle line 321a and output line 325a. Pump 326b has an input line 323b and an output that splits into recycle line 321b and output line 325b. Pump 326c has input line 323c and an output that splits into recycle line 321c and output line 325c. A common input line 323 splits into the input lines 323a-c for each of the respective pumps 326a-c. A common output line 325 combines output lines 325a-c.

Configuration data can be provided to the monitoring control system prior to monitoring of the pump system, such as system 300 or system 320. The configuration data may specify the exact configuration of pumps and recycle line valves within the system. For example, pumps can be in parallel loops, in merging loops, or in other configurations as described previously. The configuration data specifies what effect opening or closing the recycle line valve has on the one or more pumps within the system, for example, opening a particular recycle line down may increase flow on a particular pump within the pump system or a plurality of pumps within the pump system. The configuration data can also specify whether or not flow can be diverted to one or more pumps so that a particular pump can be shut down temporarily or for an extended period of time within the pump system. For example, the configuration data can specify what the effect shutting down a particular pump will have on the plurality of other pumps within the system and whether or not each other individual pump in the system has an increased fluid flow or not based on shutting down that particular pump, the configuration data also specify what proportion of increased flow each of the other pumps in the system has as a result of shutting down the particular pump. In this way, the monitoring control system has enough data such that opening any recycle line valve or shutting down any pump in the pump system has a known result or effect on the rest of the pump system.

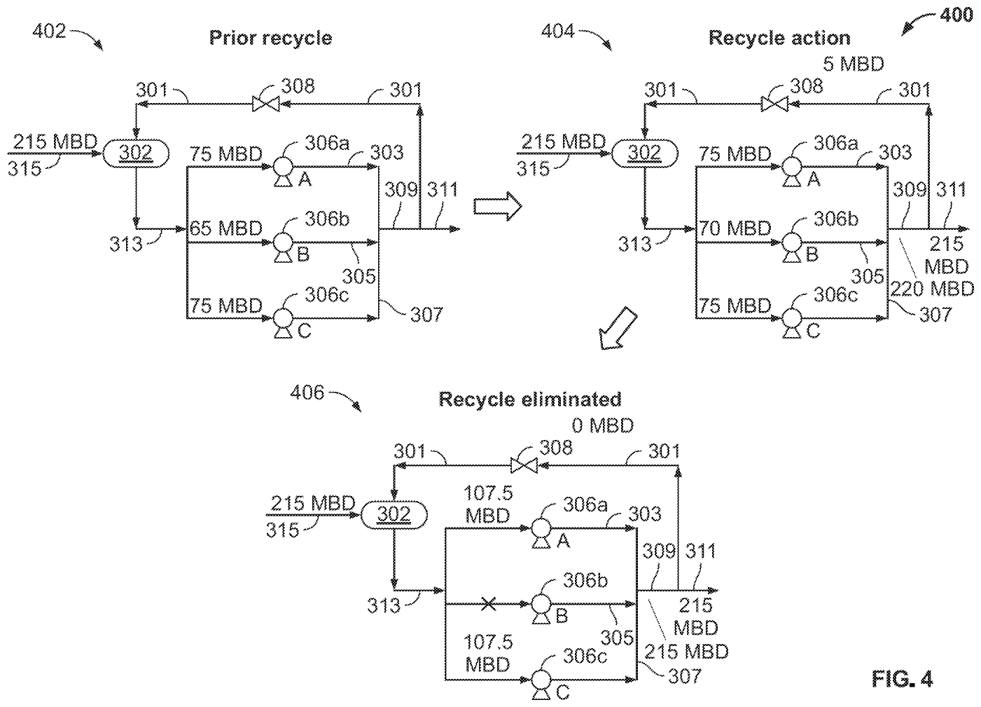

FIG. 4 includes diagrams that illustrate a process 400 of reducing or eliminating recycle flow in a pump system by the monitoring and control system. In this example, pumps 306a, 306b and 306c are identical to one another. Each of the pumps 306 has a minimum allowable operating capacity of 70 MBD, while the max operating rate is 120 MBD for each pump 306a-c. In this example, an operating rate lower than 70 MBD triggers the recycle valve 308 to open at least partially. In this case, the three pumps 306a-c are running. However, one pump 306b is operating lower than the specified minimum rate. The Monitoring and control system, to protect this pump, determines that 5 MBD is to be recycled through the line 301 to ensure pump 306b is Operating with a flow rate of at least 70 MBD.

The monitoring and control system, to eliminate the recycle but still ensure that the flow rates through all of the pumps meet their minimums, determines that a remedial action can be performed. The monitoring and control system determines that the remedial action includes distributing load from pump 306b to pumps 306a and 306c and shutting down pump 306b. By shutting down one of the three pumps 306, the monitoring control system can ensure that the minimum flow rates for each pump are achieved without requiring recycling through line 301. In this case, the remaining pumps 306a and 306c are capable of handling the excess fluid flow that would have flowed through line 305 and pump 306b. For example, assuming that there is an equal split of the excess fluid flow from pump 306b to pumps 306a and 306c, pumps 306a and 306c each have a flow of 107.5 MBD. This results in a total flow of 215 MBD without any recycle. The operational power required for operation of the system 300 is reduced.

The process 400 shows, at step 402, all three pumps 306a-c operating as previously described. At step 404, the flow rate for pump 306b drops to less than 75 MBD. The monitoring control system determines that a remedial action of recycle flow of 5 MBD in line 301 is being proposed to ensure a minimum flow rate is achieved for pump 306b. The monitoring control system determines that this recycle action either will occur or is occurring. The monitoring and control system determines that a remedial action can be performed to ensure minimum flow rates are achieved and power consumption is reduced by shutting down pump 306b, as shown in step 406. As previously described, shutting down pump 306b enables minimum flow rates to be achieved for each of the pumps 306a-c without requiring the recycle action of 5 MBD (or any other value) to be performed.

The remedial action of the monitoring and control system eliminates the recycling action entirely and saves power. The monitoring and control system determines that this remedial action can be performed based on a knowledge of the configuration of the system 300 for which through remedial action is proposed and the operating thresholds for each of the pumps 306 as well as the capacities of these pumps. The monitoring and control system therefore determines that it is possible to shut down pump 306b and still maintain proper operation of the system 300. The monitoring and control system also anticipates the recycle action is to occur when a minimum threshold for a particular pump is not satisfied or is trending to fail to satisfy the threshold. The monitoring and control system can therefore enable a faster reaction to this potential fault and cause the remedial action to be performed earlier than if the manual operation were performed.

The faster reaction of the monitoring and control system relative to manual detection and operation of the pump system 300 further reduces power consumption, preserve equipment, and shortens the period for which remedial action is needed. The Prediction capabilities of the monitoring and control system shortens a downtime of any of the pumps 306 in the system and reduces a time period for which a pump (such as pump 306b) is operating below the minimum threshold. This ensures that the pumps are operating within their nominal operational flow ranges percentages of the uptime of the system 300, which can increase equipment longevity and reduce maintenance costs.

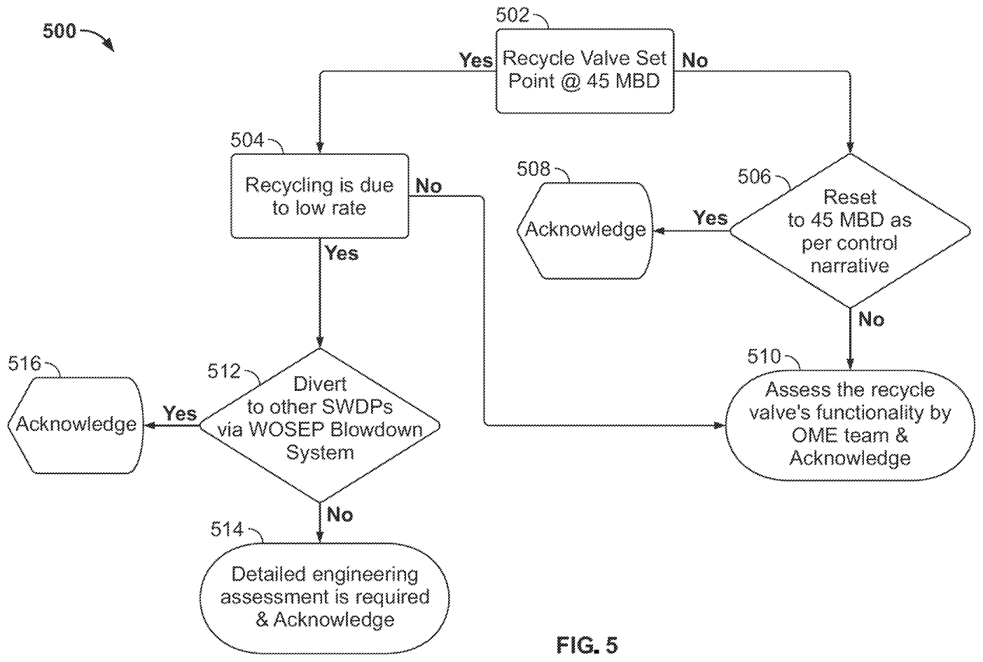

FIG. 5 is a flow diagram that illustrates a process 500 for determining remedial actions when recycle flow is not reduced or eliminated. In the particular example of process 500, the monitoring and control system is configured to detect that remedial action is needed and cause the remedial action to occur. In a first step 502, the monitoring control system sets a recycle valve set point to a threshold value, such as 45 MBD. The threshold value is the value at which recycle flow occurs to increase the flow rate above the threshold value (e.g., of 45 MBD). The monitoring and control system is configured to determine at step 502 whether or not this threshold is passed and therefore whether recycling flow is occurring. If low flow rate is occurring, then the monitoring and control system proceeds to step 504. At step 504, the monitoring and control system determines whether recycling flow is occurring due to a low flow rate through the pump. If the low flow rate is occurring, then the monitoring and control system proceeds to step 512. If a low flow rate is not occurring, then the monitoring and control system proceeds to step 510.

When the recycling flow rate is too low, and therefore the monitoring and control system proceeds to step 512. At step 512 comma the monitoring and control system determines whether to divert the flow to other pumps, such as saltwater disposal pumps (SWDPs) within the pump system. In some implementations, the monitoring control system can determine, at step 512, whether to divert fluid flow to a water oil separation blowdown system. The determination at step 512 can be based on a particular configuration of the pump system that is being monitored by the monitoring and control system. For example, if no other pumps are available, then the monitoring and control system cannot divert flow to those other pumps and instead must cause recycle flow to occur or otherwise control the main pump to slow down or turn off. The monitoring and control system uses the configuration data to make this determination as previously described in relation to FIG. 3A-3B.

In some implementations, the monitoring and control system, at step 512, determines that fluid flow should be diverted to other pumps or to a separation blowdown system. In this case, the monitoring and control system proceeds to step 515. The monitoring control system generates, at step 516, an alert requesting approval for this action or acknowledgement of this decision by an operator of the pump system. In some implementations, the monitoring control system can make this recommendation with a corresponding confidence value. The confidence value could indicate how certain the monitoring control system is about the recommendation being suggested at step 516. In some implementations, if the recommendation is made with a confidence value that exceeds a given threshold, the monitoring control system can automatically perform the remedial action recommended at step 516. In some implementations, the monitoring and control system can provide the alert and wait for operate or validation of the remedial action that is recommended. In this example, the monitoring control system can escalate the urgency and number of operators reached by the alert or other message that is generated by the monitoring and control system to ensure that one or more operators respond in a timely manner to the recommendation and so that the remedial action is performed within a time threshold.

At step 510, the monitoring control system determines that recycling is not due to a low flow rate from step 504, at step 510, the monitoring and control system is configured to access the recycle valves functionality by alerting one or more operators of the pump system, such as an operator or maintenance official that is associated with the hardware including the recycle valve, in this case, there is likely a hardware issue, rather than they need to perform a remedial action including diverting fluid flow within the pump system or causing additional recycling fluid flow to occur.

Returning back to step 502, the monitoring control system determines whether the recycle valve set point is at the threshold that is recommended by the control system. As previously stated, if the recycle valve set point is at an optimal value, the monitoring and control system proceeds to step 504 and measures the recycling rate or rates within the system at one or more recycling lines. However, if the recycle valve set point is not set at an optimal threshold, the monitoring and control system is configured to reset, at step 506, the recycle valve to a set point that is considered optimal for the particular pump system, in some implementations, the monitoring and control system can request, at step 508, approval or acknowledgement from one or more operators of the pump system to perform the remedial action of resetting the valve set point, as previously described in relation to step 516, the monitoring and control system can make such a recommendation at step 508 with an associated confidence value. If the confidence value associated with their recommended remedial action is above a threshold value, the monitoring and control system can automatically perform the remedial action without user intervention. However, if the recommendation is made with a confidence value that does not exceed the threshold, the monitoring and control system waits for validation by one or more operators of the pump system. If validation or confirmation is not received within a threshold amount of time, the monitoring control system can escalate the alert or recommendation to one or more other operators of the monitoring control system by sending the recommendation or request to additional remote devices associated with additional operators of the monitoring and control system.

The monitoring control system attempts to reset the valve set point value at step 506, as previously described. If the monitoring and control system cannot confirm that the valve set point has been reset to the desired set point value, or if there is an issue resetting the recycle valve to the desired set point value, the monitoring and control system can proceed to step 510, described previously. In this case, it is apparent that there is a hardware issue with the recycle valve itself. Because the monitoring and control system cannot remediate the issue using one or more control signals, the monitoring and control system generates and sends an alert or message to one or more operators of the pump system. The alert or message indicates that there is a hardware issue with the pump system and that it may be necessary to update, replace, or otherwise investigate the actual hardware of the pump system by one or more of the operators of the pump system.

The process 500 described herein enables the monitoring control system to investigate and remediate issues that arise when recycle flow is detected or otherwise encountered. As previously described, in some instances it is necessary to cause one or more operators of the pump system to investigate hardware of the pump system that may be malfunctioning. In other scenarios, the monitoring and control system can automatically reduce or eliminate recycle line fluid flow by controlling fluid flow within the pump system without intervention by one or more pump operators, or with simple validation or confirmation received by one or more operators. This enables operators of the pump system to focus on repairing deficient hardware, and the monitoring control system can automatically regulate fluid flow within the pump system. The monitoring and control system thus facilitates control of fluid flow within the pump system by reducing and eliminating recycle line fluid flow in a quick and efficient manner.

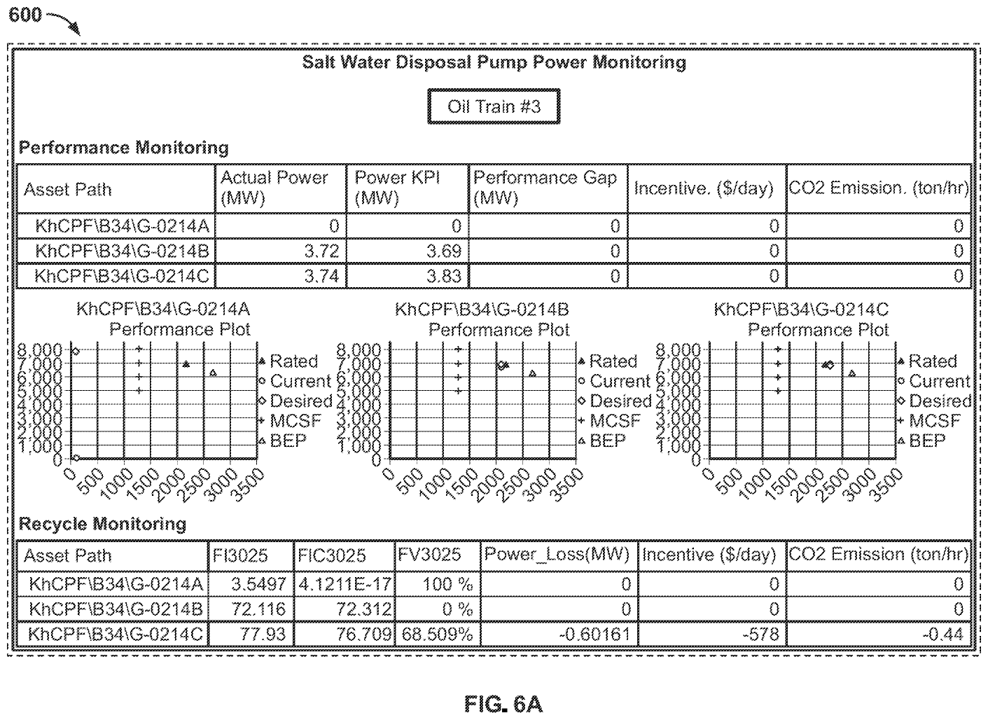

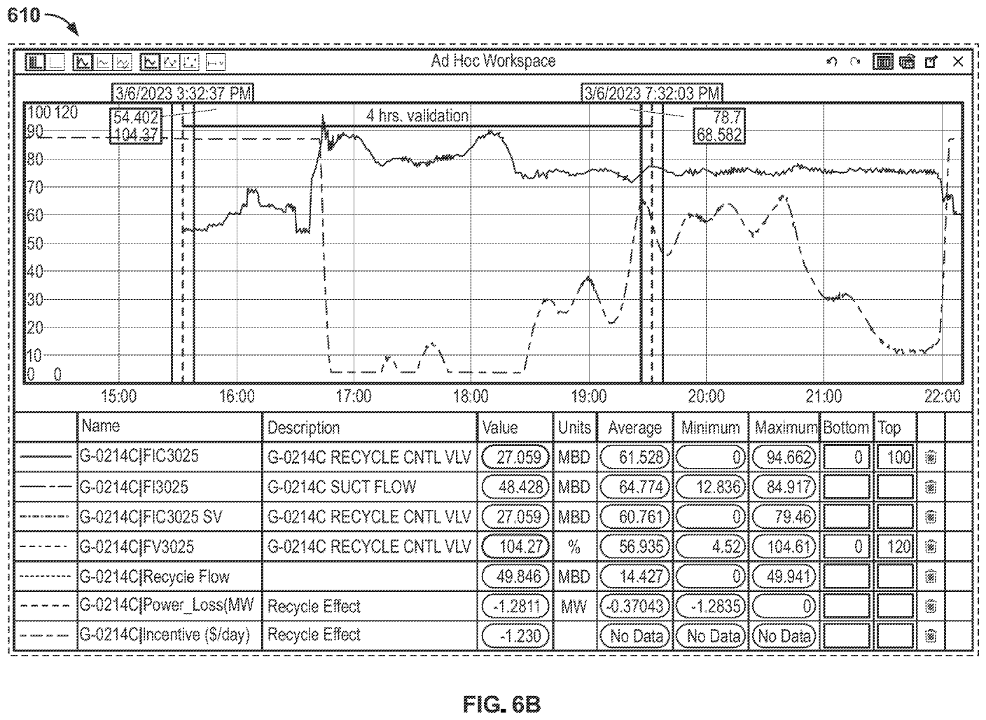

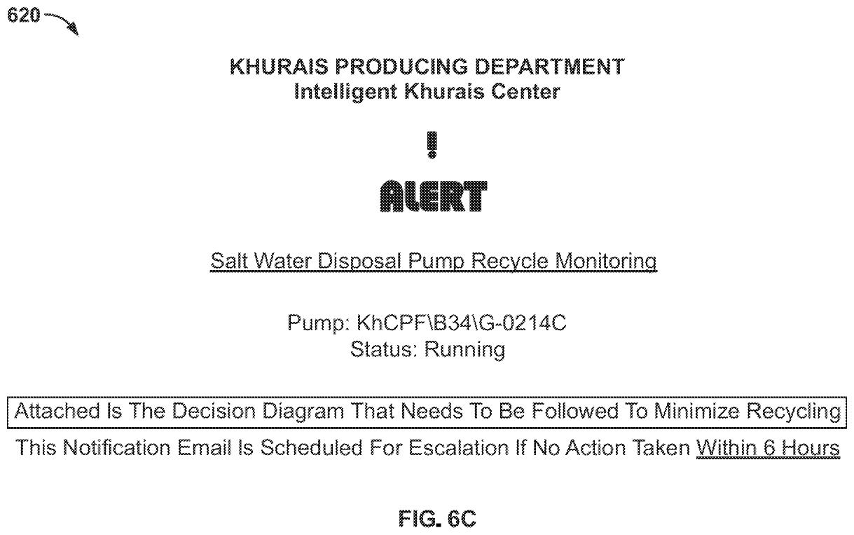

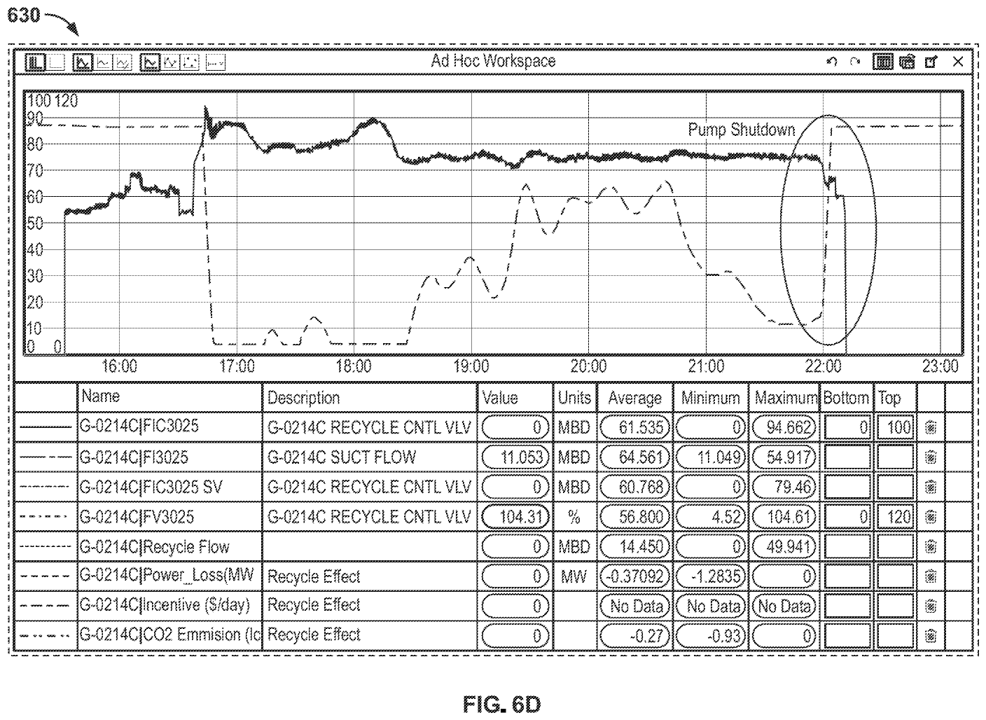

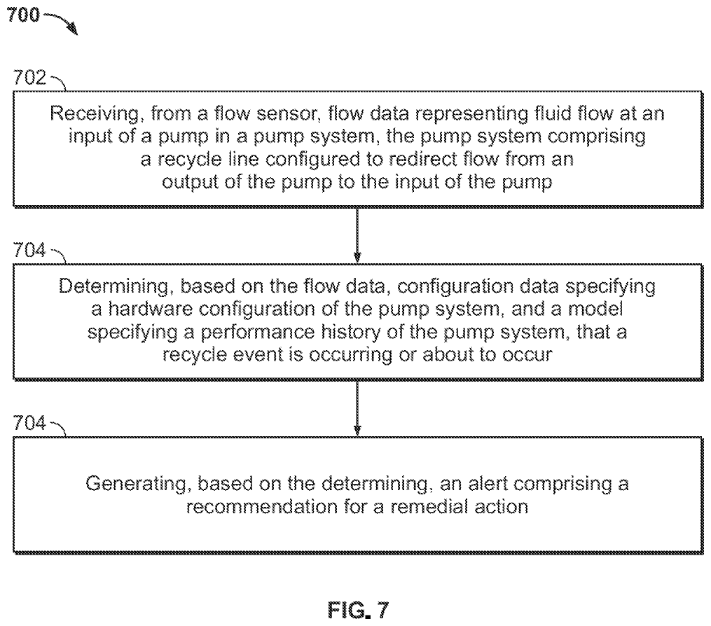

FIGS. 6A-6D each include a respective user interface 600, 610, 620, and 630 of the pump monitoring and control system. In FIG. 6A, the user interface 600 represents a performance monitoring dashboard for each pump within a pump system, and a recycle line monitoring dashboard for each recycle line within the pump system. Additionally, performance plots show activity for each of the pumps within the pump system. For example, each pump can be shown with data representing an actual power consumption, a power target performance, a performance gap that is identified, a financial cost or incentive, and in associated carbon footprint. In addition, a graph can show these metrics in a visualization. As illustrated, when the system captured a recycle event, it estimates the power loss of 0.6 MW, with incentive opportunity of $578/day and CO2 emissions reduction opportunity of 0.44 ton/hr.

FIG. 6B shows a user interface 610 in which a recycle line valve operation is shown over time, in this example, the valve position is shown over the course of several hours. The system is configured to monitor the valve position and determine when the recycle line is allowing fluid flow to occur and when the recycle line is not allowing fluid flow to occur. As shown in user interface 610, the valve is opened from a closed position at hour 17, the monitoring and control system monitors the valve position over a four hour window to determine whether a remedial action should be recommended or automatically performed. The recycle line valve moves to a further closed position during the validation window. At the end of the validation window, the monitoring and control system can look at the valve position throughout the validation window and determine whether a remedial action or alert is necessary. For example, after the four hour validation window, if the recycle line valve is in a closed or approximately closed position and the recycle line event appears to have passed, the monitoring and control system may determine that no alert is necessary. However, if the recycle line valve is still fully open or mostly open after the four hour validation window, the monitoring and control system can generate an alert to invoke intervention from one or more operators or automatically perform a remedial action.

FIG. 6C shows a user interface 620 that includes an alert. The alert of user interface 620 includes a specific recitation of the hardware involved with the recycle line flow and can include an attached diagram that shows where in the pump system remedial action should be performed. The alert is set for 6 hrs. escalation if no action is taken.

FIG. 6D shows a user interface 630 that represents a pump operation speed over a timeline. The pump operation speed can be measured either in rotations per minute or another metric. In some implementations, operators can review the alert and determine that a shutdown of the equipment is to be taken to prevent unnecessary recycling. As shown in user interface 630, a pump shut down occurs at approximately hour 22. The pump shut down is responsive to a recycle line valve being opened for an extended period of time as seen in a second data line within the user interface 630. As shown in the user interface 630, once the pump shut down occurs near hour 22, the recycle line valve moves to a fully closed position. Shutting down the pump has reduced recycle line flow and eliminated inefficiency within the pump system, as fluid is diverted to one or more other pumps.

FIG. 7 shows an example process 700 for monitoring and controlling a pump system, as described herein. In some implementations, the process 700 is performed by a data processing system including one or more processors. The data processing system can be in communication with one or more sensors of the pump system, such as described in relation to FIGS. 1-6D.

The process 700 for controlling a pump system includes receiving (702), from a flow sensor, flow data representing fluid flow at an input of a pump in a pump system, the pump system comprising a recycle line configured to redirect flow from an output of the pump to the input of the pump. The process 700 includes determining (704), based on the flow data, configuration data specifying a hardware configuration of the pump system, and a model specifying a performance history of the pump system, that a recycle event is occurring or about to occur. The process 700 includes generating (706), based on the determining, an alert comprising a recommendation for a remedial action to reduce an amount of fluid flow through the recycle line during the recycle event relative to a baseline amount of fluid flow through the recycle line.

In some implementations, the process 700 includes causing performance of the remedial action in the pump system. In some implementations, causing performance of the remedial action in the pump system occurs automatically based on a confidence value associated with the recommendation. In some implementations, causing performance of the remedial action in the pump system occurs after receiving validation input from an operator of the pump system.

In some implementations, reducing the amount of fluid flow through the recycle line comprises eliminating fluid flow through the recycle line and preventing the recycle event.

In some implementations, the remedial action comprises shutting down the pump and diverting fluid flow to one or more other pumps in the pump system.

In some implementations, the remedial action comprises opening a recycle line valve on the recycle line to control fluid flow through the recycle line.

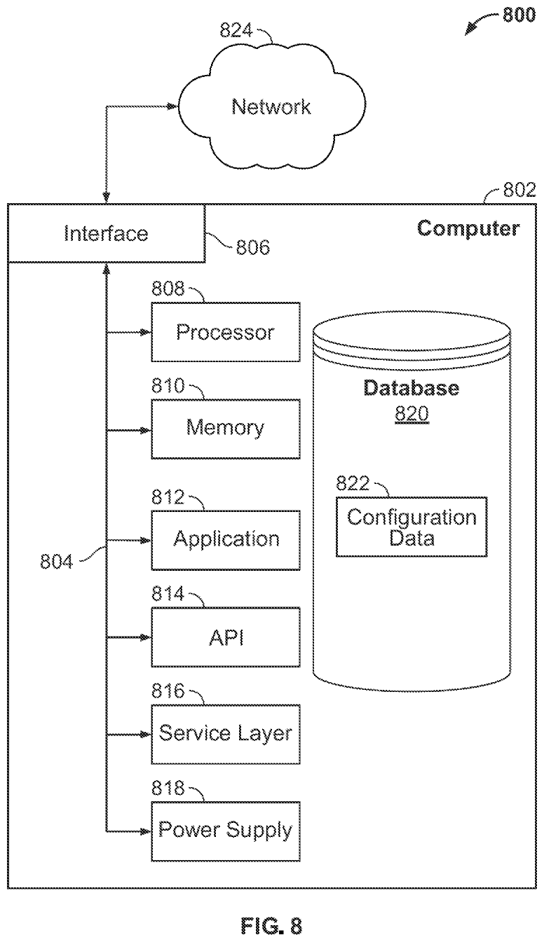

FIG. 8 is a block diagram of an example computer system 800 used to provide computational functionalities associated with described algorithms, methods, functions, processes, flows, and procedures described in the present disclosure, according to some implementations of the present disclosure. The illustrated computer 802 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 802 can include input devices such as keypads, keyboards, and touch screens that can accept user information. Also, the computer 802 can include output devices that can convey information associated with the operation of the computer 802. The information can include digital data, visual data, audio information, or a combination of information. The information can be presented in a graphical user interface (UI) (or GUI).

The computer 802 can serve in a role as a client, a network component, a server, a database, a persistency, or components of a computer system for performing the subject matter described in the present disclosure. The illustrated computer 802 is communicably coupled with a network 824. In some implementations, one or more components of the computer 802 can be configured to operate within different environments, including cloud-computing-based environments, local environments, global environments, and combinations of environments.

At a high level, the computer 802 is an electronic computing device operable to receive, transmit, process, store, and manage data and information associated with the described subject matter. According to some implementations, the computer 802 can also include, or be communicably coupled with, an application server, an email server, a web server, a caching server, a streaming data server, or a combination of servers.

The computer 802 can receive requests over network 824 from a client application (for example, executing on another computer 802). The computer 802 can respond to the received requests by processing the received requests using software applications. Requests can also be sent to the computer 802 from internal users (for example, from a command console), external (or third) parties, automated applications, entities, individuals, systems, and computers.

Each of the components of the computer 802 can communicate using a system bus 804. In some implementations, any or all of the components of the computer 802, including hardware or software components, can interface with each other or the interface 806 (or a combination of both), over the system bus 804. Interfaces can use an application programming interface (API) 814, a service layer 816, or a combination of the API 814 and service layer 816. The API 814 can include specifications for routines, data structures, and object classes. The API 814 can be either computer-language independent or dependent. The API 814 can refer to a complete interface, a single function, or a set of APIs.

The service layer 816 can provide software services to the computer 802 and other components (whether illustrated or not) that are communicably coupled to the computer 802. The functionality of the computer 802 can be accessible for all service consumers using this service layer. Software services, such as those provided by the service layer 816, can provide reusable, defined functionalities through a defined interface. For example, the interface can be software written in JAVA, C++, or a language providing data in extensible markup language (XML) format. While illustrated as an integrated component of the computer 802, in alternative implementations, the API 814 or the service layer 816 can be stand-alone components in relation to other components of the computer 802 and other components communicably coupled to the computer 802. Moreover, any or all parts of the API 814 or the service layer 816 can be implemented as child or sub-modules of another software module, enterprise application, or hardware module without departing from the scope of the present disclosure.

The computer 802 includes an interface 806. Although illustrated as a single interface 806 in FIG. 8, two or more interfaces 806 can be used according to implementations of the computer 802 and the described functionality. The interface 806 can be used by the computer 802 for communicating with other systems that are connected to the network 824 (whether illustrated or not) in a distributed environment. Generally, the interface 806 can include, or be implemented using, logic encoded in software or hardware (or a combination of software and hardware) operable to communicate with the network 824. More specifically, the interface 806 can include software supporting one or more communication protocols associated with communications. As such, the network 824 or the interface's hardware can be operable to communicate physical signals within and outside of the illustrated computer 802.

The computer 802 includes a processor 808. Although illustrated as a single processor 808 in FIG. 8, two or more processors 808 can be used according to implementations of the computer 802 and the described functionality. Generally, the processor 808 can execute instructions and can manipulate data to perform the operations of the computer 802, including operations using algorithms, methods, functions, processes, flows, and procedures as described in the present disclosure.

The computer 802 also includes a database 820 that can hold data (such as pump data or configuration data 822) for the computer 802 and other components connected to the network 824 (whether illustrated or not). For example, database 820 can be an in-memory, conventional, or a database storing data consistent with the present disclosure. In some implementations, database 820 can be a combination of two or more different database types (for example, hybrid in-memory and conventional databases) according to implementations of the computer 802 and the described functionality. Although illustrated as a single database 820 in FIG. 8, two or more databases (of the same, different, or combination of types) can be used according to implementations of the computer 802 and the described functionality. While database 820 is illustrated as an internal component of the computer 802, in alternative implementations, database 820 can be external to the computer 802.

The computer 802 also includes a memory 810 that can hold data for the computer 802 or a combination of components connected to the network 824 (whether illustrated or not). Memory 810 can store any data consistent with the present disclosure. In some implementations, memory 810 can be a combination of two or more different types of memory (for example, a combination of semiconductor and magnetic storage) according to implementations of the computer 802 and the described functionality. Although illustrated as a single memory 810 in FIG. 8, two or more memories 810 (of the same, different, or combination of types) can be used according to implementations of the computer 802 and the described functionality. While memory 810 is illustrated as an internal component of the computer 802, in alternative implementations, memory 810 can be external to the computer 802.

The application 812 can be an algorithmic software engine providing functionality according to implementations of the computer 802 and the described functionality. For example, application 812 can serve as one or more components, modules, or applications. Further, although illustrated as a single application 812, the application 812 can be implemented as multiple applications 818 on the computer 802. In addition, although illustrated as internal to the computer 802, in alternative implementations, the application 812 can be external to the computer 802.

The computer 802 can also include a power supply 818. The power supply 818 can include a rechargeable or non-rechargeable battery that can be configured to be either user- or non-user-replaceable. In some implementations, the power supply 818 can include power-conversion and management circuits, including recharging, standby, and power management functionalities. In some implementations, the power-supply 818 can include a power plug to allow the computer 802 to be plugged into a wall socket or a power source to, for example, power the computer 802 or recharge a rechargeable battery.

There can be any number of computers 802 associated with, or external to, a computer system containing computer 802, with each computer 802 communicating over network 824. Further, the terms “client,” “user,” and other appropriate terminology can be used interchangeably, as appropriate, without departing from the scope of the present disclosure. Moreover, the present disclosure contemplates that many users can use one computer 802 and one user can use multiple computers 802.

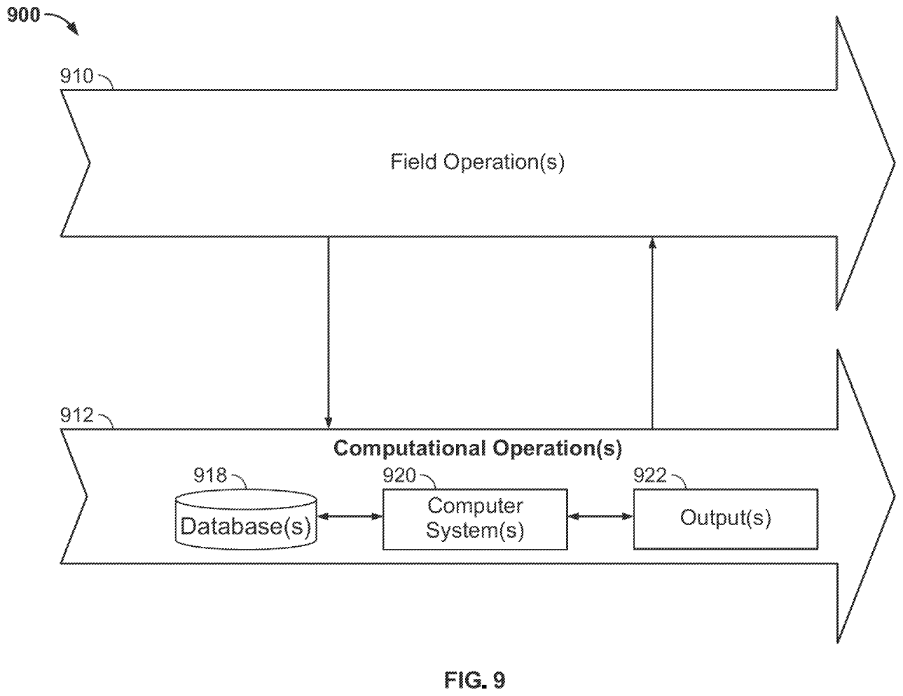

FIG. 9 illustrates hydrocarbon production operations 900 that include both one or more field operations 910 and one or more computational operations 912, which exchange information and control exploration to produce hydrocarbons. In some implementations, outputs of techniques of the present disclosure (e.g., the method 300) can be performed before, during, or in combination with the hydrocarbon production operations 900, specifically, for example, either as field operations 910 or computational operations 912, or both. For example, the method 300 collects data during field operations, processes the data in computational operations, and can determine locations to perform additional field operations.

Examples of field operations 910 include forming/drilling a wellbore, hydraulic fracturing, producing through the wellbore, injecting fluids (such as water) through the wellbore, to name a few. In some implementations, methods of the present disclosure can trigger or control the field operations 910. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 910 and responsively triggering the field operations 910 including, for example, generating plans and signals that provide feedback to and control physical components of the field operations 910. Alternatively, or in addition, the field operations 910 can trigger the methods of the present disclosure. For example, implementing physical components (including, for example, hardware, such as sensors) deployed in the field operations 910 can generate plans and signals that can be provided as input or feedback (or both) to the methods of the present disclosure.

Examples of computational operations 912 include one or more computer systems 920 that include one or more processors and computer-readable media (e.g., non-transitory computer-readable media) operatively coupled to the one or more processors to execute computer operations to perform the methods of the present disclosure. The computational operations 912 can be implemented using one or more databases 918, which store data received from the field operations 910 and/or generated internally within the computational operations 912 (e.g., by implementing the methods of the present disclosure) or both. For example, the one or more computer systems 920 process inputs from the field operations 910 to assess conditions in the physical world, the outputs of which are stored in the databases 918. For example, seismic sensors of the field operations 910 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 912 where they are stored in the databases 918 and analyzed by the one or more computer systems 920.

In some implementations, one or more outputs 922 generated by the one or more computer systems 920 can be provided as feedback/input to the field operations 910 (either as direct input or stored in the databases 918). The field operations 910 can use the feedback/input to control physical components used to perform the field operations 910 in the real world.

For example, the computational operations 912 can process the seismic data to generate three-dimensional (3D) maps of the subsurface formation. The computational operations 912 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 912 to process new information about the formation and control the drilling to adjust to the observed conditions in real-time.

The one or more computer systems 920 can update the 3D maps of the subsurface formation as information from one exploration well is received and the computational operations 912 can adjust the location of the next exploration well based on the updated 3D maps. Similarly, the data received from production operations can be used by the computational operations 912 to control components of the production operations. For example, production well and pipeline data can be analyzed to predict slugging in pipelines leading to a refinery and the computational operations 912 can control machine operated valves upstream of the refinery to reduce the likelihood of plant disruptions that run the risk of taking the plant offline.

In some implementations of the computational operations 912, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, accounting for processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are in different countries or other jurisdictions.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively. or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS. ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile-non-volatile memory, media, and memory devices. Computer readable media can include, for example, semiconductor memory devices such as random-access memory (RAM), read only memory (ROM), phase change memory (PRAM), static random-access memory (SRAM), dynamic random-access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Several implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Several embodiments of these systems and methods have been described. Nevertheless, it will be understood that various modifications may be made without departing from the spirit and scope of this disclosure. Accordingly, other embodiments are within the scope of the following claims.

Several embodiments have been described. Nevertheless, it will be understood that various modifications may be made without departing from the scope of the data processing system described herein. Accordingly, other embodiments are within the scope of the following claims.

What is claimed is:

1. A method for controlling a pump system, the method comprising:
receiving, from a flow sensor, flow data representing fluid flow at an input of a pump in a pump system, the pump system comprising a recycle line configured to redirect flow from an output of the pump to the input of the pump;
determining, based on the flow data, configuration data specifying a hardware configuration of the pump system, and a model specifying a performance history of the pump system, that a recycle event is occurring or about to occur; and
generating, based on the determining, an alert comprising a recommendation for a remedial action to reduce an amount of fluid flow through the recycle line during the recycle event relative to a baseline amount of fluid flow through the recycle line.

2. The method of claim 1, further comprising causing performance of the remedial action in the pump system.

3. The method of claim 1, wherein causing performance of the remedial action in the pump system occurs automatically based on a confidence value associated with the recommendation.

4. The method of claim 1, wherein causing performance of the remedial action in the pump system occurs after receiving validation input from an operator of the pump system.

5. The method of claim 1, wherein reducing the amount of fluid flow through the recycle line comprises eliminating fluid flow through the recycle line and preventing the recycle event.

6. The method of claim 1, wherein the remedial action comprises shutting down the pump and diverting fluid flow to one or more other pumps in the pump system.

7. The method of claim 1, wherein the remedial action comprises opening a recycle line valve on the recycle line to control fluid flow through the recycle line.

8. A system for controlling a pump, the system comprising:
a flow sensor configured to measure flow data representing fluid flow at the flow sensor;
a pump; and
at least one controller, the controller configured to perform operations comprising:
receiving, from the flow sensor, flow data representing the fluid flow at an input of the pump in a pump system, the pump system comprising a recycle line configured to redirect flow from an output of the pump to the input of the pump;
determining, based on the flow data, configuration data specifying a hardware configuration of the pump system, and a model specifying a performance history of the pump system, that a recycle event is occurring or about to occur; and
generating, based on the determining, an alert comprising a recommendation for a remedial action to reduce an amount of fluid flow through the recycle line during the recycle event relative to a baseline amount of fluid flow through the recycle line.

9. The system of claim 8, the operations further comprising causing performance of the remedial action in the pump system.

10. The system of claim 8, wherein causing performance of the remedial action in the pump system occurs automatically based on a confidence value associated with the recommendation.

11. The system of claim 8, wherein causing performance of the remedial action in the pump system occurs after receiving validation input from an operator of the pump system.

12. The system of claim 8, wherein reducing the amount of fluid flow through the recycle line comprises eliminating fluid flow through the recycle line and preventing the recycle event.

13. The system of claim 8, wherein the remedial action comprises shutting down the pump and diverting fluid flow to one or more other pumps in the pump system.

14. The system of claim 8, wherein the remedial action comprises opening a recycle line valve on the recycle line to control fluid flow through the recycle line.

15. One or more non-transitory computer readable media storing instructions for controlling a pump in a pump system by a controller, the instructions, when executed by a processor of the controller, configured to cause the controller to perform operations comprising:
receiving, from a flow sensor, flow data representing fluid flow at an input of a pump in a pump system, the pump system comprising a recycle line configured to redirect flow from an output of the pump to the input of the pump;
determining, based on the flow data, configuration data specifying a hardware configuration of the pump system, and a model specifying a performance history of the pump system, that a recycle event is occurring or about to occur; and
generating, based on the determining, an alert comprising a recommendation for a remedial action to reduce an amount of fluid flow through the recycle line during the recycle event relative to a baseline amount of fluid flow through the recycle line.

16. The one or more non-transitory computer readable media of claim 15, the operations further comprising causing performance of the remedial action in the pump system.

17. The one or more non-transitory computer readable media of claim 15, wherein causing performance of the remedial action in the pump system occurs automatically based on a confidence value associated with the recommendation.

18. The one or more non-transitory computer readable media of claim 15, wherein causing performance of the remedial action in the pump system occurs after receiving validation input from an operator of the pump system.

19. The one or more non-transitory computer readable media of claim 15, wherein reducing the amount of fluid flow through the recycle line comprises eliminating fluid flow through the recycle line and preventing the recycle event.

20. The one or more non-transitory computer readable media of claim 15, wherein the remedial action comprises shutting down the pump and diverting fluid flow to one or more other pumps in the pump system.
